(19) United States
(12) Patent Application Publication
(10) Pub. No.: US 2008/0177784 A1
(43) Pub. Date: Jul. 24, 2008

(54) JAVA DATE CLASS OBJECTS

(76) Inventors: Anshul DAWRA, San Jose, CA (US); Paul A. OSTLER, San Francisco, CA (US); Paul A. WEBB, San Jose, CA (US)

Correspondence Address: SAWYER LAW GROUP LLP, P.O. BOX 51418, PALO ALTO, CA, 94303, US

(21) Appl. No.: 11/626,065

(22) Filed: Jan. 23, 2007

(51) Int. Cl. G06F 17/30

(52) U.S. Cl. 707/103 R; 707/E17.055

(57) ABSTRACT

A method and a computer program product for storing a specific instant in time as a java.util.Date object are provided. The method and the computer program product provide for defining a first enhanced class that extends java.sql.Date, defining a second enhanced class that extends java.sql.Time, defining a third enhanced class that extends java.sql.Timestamp, creating a first object of the java.util.Calendar class, creating a second object that stores a specific instant in time in a first time zone, and creating a third object based on the first object, the second object, and a provided value, the provided value corresponding to a second time zone and the third object storing a particular instant in time in the second time zone corresponding to the specific instant in time in the first time zone.

### FIELD OF THE INVENTION

The present invention relates generally to Java™ Date class objects.

### BACKGROUND OF THE INVENTION

With Java™ (an object-oriented programming language developed by Sun Microsystems®, Inc. of Santa Clara, Calif.), the Date class (i.e., java.util.Date class) can be used to create an object to store a specific instant in time, such as Jan. 1, 2000 at 13:02:50 (i.e., 2 minutes and 50 seconds past 1 p.m.). What is actually stored in the Date class object, however, is an epoch time corresponding to the specific instant in time. The epoch time is the number of milliseconds that have elapsed from Jan. 1, 1970 at midnight Greenwich Mean Time (GMT) to the specific instant in time.

The epoch time stored in the Date class object is calculated based on the time zone of the computer system on which the Date class object is created. As a result, objects of the Date class are not amenable to internationalization (i.e., utilization across different time zones around the world). Java™ also includes a Calendar class (i.e., java.util.Calendar class) that can be used to store a specific instant in time. Since the Calendar class does not have the same local time zone dependency as the Date class, it is amenable to internationalization.

Some application programming interfaces (APIs) and programs, however, need to use Date class objects. Therefore, these APIs and programs require a functioning Date class that is amenable to internationalization.

### SUMMARY OF THE INVENTION

A method and a computer program product for storing a specific instant in time as an object of the java.util.Date class are provided. The method and the computer program product provide for defining a first enhanced class, the first enhanced class extending the java.sql.Date subclass of the java.util.Date class, defining a second enhanced class, the second enhanced class extending the java.sql.Time subclass of the java.util.Date class, defining a third enhanced class, the third enhanced class extending the java.sql.Timestamp subclass of the java.util.Date class, creating a first object, the first object being an object of the java.util.Calendar class, creating a second object, the second object storing a specific instant in time in a first time zone and being an object of the java.sql.Date subclass, the java.sql.Time subclass, or the java.sql.Timestamp subclass, and creating a third object based on the first object, the second object, and a provided value, the provided value corresponding to a second time zone, the third object storing a particular instant in time in the second time zone corresponding to the specific instant in time in the first time zone, and the third object being an object of the first enhanced class when the second object is an object of the java.sql.Date subclass, an object of the second enhanced class when the second object is an object of the java.sql.Time subclass, or an object of the third enhanced class when the second object is an object of the java.sql.Timestamp subclass.

### BRIEF DESCRIPTION OF THE DRAWINGS

FIG. 1 depicts a process flow of a method for storing a specific instant in time as an object of the java.util.Date class according to an implementation of the invention

FIG. 2 illustrates a block diagram of a system according to an implementation of the invention.

FIG. 3 shows a block diagram of the java.util.Date class according to an implementation of the invention.

FIG. 4 illustrates a block diagram of a data processing system with which implementations of the invention can be implemented.

### DETAILED DESCRIPTION

The present invention generally relates to Java™ Date class objects. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

Objects created using the Date class (i.e., the java.util.Date class) in Java™ an object-oriented programming language developed by Sun Microsystems®, Inc. of Santa Clara, Calif., can be used to store specific instances in time. A specific instant in time is stored in a Date class object in epoch time format. The epoch time corresponding to a specific instant in time is the number of milliseconds that have elapsed from Jan. 1, 1970 at midnight Greenwich Mean Time (GMT) to the specific instant in time. For instance, if the specific instant in time is Jan. 2, 2007 at 13:53:00 GMT, then the epoch time corresponding to the specific instant in time is 1167745980.

Calculation of the epoch time for a specific instant in time is based on the time zone of the computer system on which the Date class object is created. If, for example, the Date class object was created on a computer system located in California, then the epoch time stored in the Date class object will be 1167774780, which is 13:53:00 Pacific Standard Time (PST) or 21:53:00 GMT on Jan. 2, 2007. On the other hand, if the Date class object was created on a computer system located in New York, then the epoch time stored in the Date class object will be 1167763980, which is 13:53:00 Eastern Standard Time (EST) or 18:53:00 GMT on Jan. 2, 2007.

Due to the dependency on the local time zone, the Date class is not amenable to internationalization (i.e., utilization across different time zones around the world). In addition, the Date class has problems handling Daylight Savings Time. For instance, if a user attempts to store Oct. 30, 2005 at 01:30:00 in a Date class object and the Date class object is being created on a computer system located in California, then Oct. 30, 2005 at 01:30:00 occurs twice due to the transition from Daylight Savings Time to Standard Time. Consequently, depending on whether the computer system is on Daylight Savings Time or on Standard Time, an epoch time of either 1130661000 (i.e., 01:30:00 Pacific Daylight Time (PDT) or 08:30:00 GMT) or 1130664600 (i.e., 01:30:00 PST or 09:30:00 GMT) may be stored in the Date class object.

To avoid the problems with the Date class, the Java™ Calendar class can be used to store specific instances in time as it is not dependent on the local time zone. Unfortunately, certain programs and Application Programming Interfaces (APIs) need to utilize Date class objects. For example, Java Database Connectivity (JDBC) includes three classes that are directly derived from the Date class, e.g., java.sql.Date, java.sql.Time, and java.sql.Timestamp, which are subclasses of the Date class. Accordingly, these programs and APIs require a functioning Date class that can be reliably used across several different systems, each with their own independent settings.

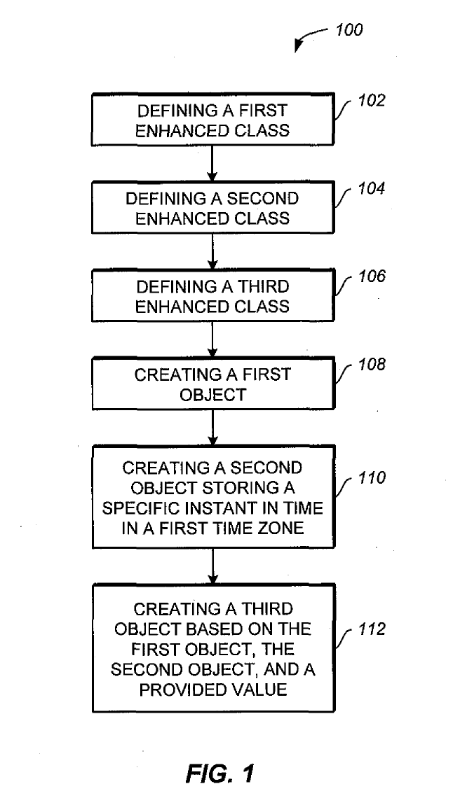

Depicted in FIG. 1 is a process 100 for storing a specific instant in time as an object of the java.util.Date class according to an implementation of the invention. At 102, a first enhanced class is defined. The first enhanced class extends the java.sql.Date subclass of the java.util.Date class. At 104, a second enhanced class is defined. The second enhanced class extends the java.sql.Time subclass of the java.util.Date class. At 106, a third enhanced class is defined. The third enhanced class extends the java.sql.Timestamp subclass of the java.util.Date class.

In one implementation, the first enhanced class is defined as a subclass of java.sql.Date, the second enhanced class is defined as a subclass of java.sql.Time, and the third enhanced class is defined as a subclass of java.sql.Timestamp. In another implementation, a fourth enhanced class may be defined that extends the java.util.Date class in a similar fashion as the first, second, and third enhanced classes.

At 108, a first object is created. The first object is an object of the java.util.Calendar class. The first object is operable to be used to convert between an object of the java.util.Date class and a set of fields, such as year, month, day, hour, minute, second, and so forth. Interpretation of a Date class object is made according to the rules of a specific calendaring system, such as the Gregorian calendar or the lunar calendar.

At 110, a second object is created. The second object stores a specific instant in time in a first time zone. In addition, the second object is an object of the java.sql.Date subclass, the java.sql.Time subclass, or the java.sql.Timestamp subclass. At 112, a third object is created based on the first object, the second object, and a provided value. The provided value corresponds to a second time zone. In one implementation, the provide value is an object of the java.util.TimeZone class.

The third object stores a particular instant in time in the second time zone corresponding to the specific instant in time in the first time zone. In the implementation, the particular instant in time in the second time zone corresponding to the specific instant in time in the first time zone is calculated using the first object. The third object is an object of the first enhanced class when the second object is an object of the java.sql.Date subclass, an object of the second enhanced class when the second object is an object of the java.sql.Time subclass, or an object of the third enhanced class when the second object is an object of the java.sql.Timestamp subclass.

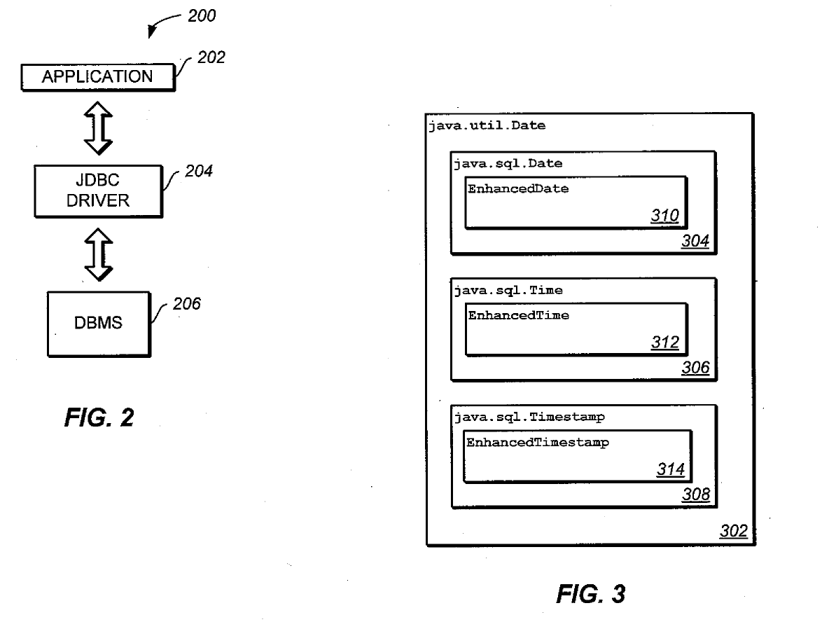

FIG. 2 illustrates a system 200 according to an implementation of the invention. System 200 includes an application 202, a JDBC driver 204, and a database management system (DBMS) 206. Application 202 may be an API or a program. DBMS 206 may include a database server (not shown) and one or more databases (not shown).

In one implementation, application 202 and JDBC driver 204 are located on a client computer system (not shown), DBMS 206 is located on a server computer system (not shown), and JDBC driver 204 communicates with DBMS 206 over a network (not shown), such as a local area network (LAN), a wide area network (WAN), or other communication network. Each of the client and server computer systems may be a desktop computer, a computer workstation, a laptop computer, a personal digital assistant (PDA), or other computing device.

Shown in FIG. 3 is a block diagram of the java.util.Date class 302 according to an implementation of the invention. The java.util.Date class 302 may be included in a JDBC driver, such as JDBC driver 204 in FIG. 2. The java.util.Date class 302 includes three subclasses, the java.sql.Date subclass 304, the java.sql.Time subclass 306, and the java.sql.Timestamp subclass 308.

A plurality of methods (not shown) are provided in the java.util.Date class 302. These methods arc inherited by each of the subclasses 304-308. Within each of the subclasses 304-308, a plurality of methods (not shown) are also provided. For example, the java.sql.Date subclass 304 includes a getHours( ) method, a getMinutes( ) method, a getseconds( ) method, a setHours( ) method, a setminutes( ) method, a setTime( ) method, a toString( ) method, and a valueOf( ) method in addition to the methods inherited from the java.util.Date class 302.

In the implementation of FIG. 3, an enhanced class has been defined within each of the subclasses 304-308. An EnhancedDate class 310 has been defined as a subclass of java.sql.Date subclass 304. An EnhancedTime class 312 has been defined as a subclass of java.sql.Time subclass 306. An EnhancedTimestamp class 314 has been defined as a subclass of java.sql.Timestamp subclass 308.

Each of the enhanced classes 310-314 extends (i.e., is a subclass of) the respective subclass 304-308 and includes the same methods and fields as the respective subclass 304-308. Presented below is a sample pseudo-code for the EnhancedTimestamp class 314 in FIG. 3.

```
public class EnhancedTimestamp extends java.sql.Timestamp
{
    private in dayOfWeek, month, year, hour, minute, second;
    public EnhancedTimestamp(java.util.Date date, java.util.Calendar cal,
    java.util.TimeZone timezone){
        //some Calendar that is stored internally
        cal.setTimezone(timezone);
        cal.setDate(date);
        month = cal.getMonth( );
        year = cal.getYear( );
        //etc.
        ...
    }
    //overrides java.util.Date
    public int getMonth( ){
        return month;
    }
    //overrides java.util.Date
    public int getHours( ){
        return hour;
    }
    {
    //get methods for other fields as well
    ...
    ...
    }
}
```

In the sample pseudo-code, the EnhancedTimestamp class 314 is passed a java.util.Date object named “date,” a java.util.Calendar object named “cal”, and a java.util.TimeZone object named “timezone”. The “cal” object is then set using the “date” object and the “timezone” object. After the “cal” object is set, the correct year, month, day, hour, minute, second, and so forth can be calculated and stored using the “cal” object. Various methods are then provided in the EnhancedTimestamp class 314 to replace methods of the java.util.Date class 302 and the java.sql.Timestamp subclass 308. Sample pseudo-code for the EnhancedTime class 310 and the EnhancedTime class 312 in FIG. 3 will be similar to the sample pseudo-code for the EnhancedTimestamp class 314, except different method(s) and/or field(s) may be included.

An object created from the EnhancedTimestamp class 314 can be accessed just like any other object of the java.util.Date class. In addition, the object may be passed to any application on any system to report a correct and consistent time value without any dependence on the local time zone of a computer system.

In another implementation, an EnhancedUtilDate class (not shown) may be defined as a subclass of the java.util.Date class 302. The EnhancedUtilDate class may be used in a similar fashion as enhanced classes 310-314 and may be in addition to or in replacement of enhanced classes 310-314. Presented below is a sample pseudo-code for the EnhancedUtilDate class:

```
public class EnhancedUtilDate extends java.util.Date
{
    private in dayOfWeek, month, year, hour, minute, second;
    public EnhancedUtilDate(java.util.Date date, java.util.Calendar cal,
    java.util.TimeZone timezone){
        //some Calendar that is stored internally
        cal.setTimezone(timezone);
        cal.setDate(date);
        month = cal.getMonth( );
        year = cal.getYear( );
        //etc.
        ...
    }
    //overrides java.util.Date
    public int getMonth( ){
        return month;
    }
    //overrides java.util.Date
    public int getHours( ){
        return hour;
    }
    {
    //get methods for other fields as well
    ...
    ...
    }
}
```

As seen from above, the sample pseudo-code for the EnhancedUtilDate class is very similar to the pseudo-code for the EnhancedTimestamp class 314. The behaviors of the two enhanced classes are so alike because the java.sql.Timestamp subclass 308 and the java.util.Date class 302 are comparable. However, the java.sql.Timestamp subclass 308 is a bit more precise than the java.util.Date class 302 as it can stores a specific instant in time with nanosecond precision.

In an example usage scenario, assume there is a database that is used by people all over the world and as a result, all time and date information is to be stored in GMT. Assume a user located in California wishes to store the local time of “Saturday, Apr. 2, 2005 at 18:30:00” into the database. The user can create an object of the java.sql.Timestamp class to store the local time in GMT by calling:
java.sql.Connection con; //assume this is a JDBC connection that is established java.sql.PreparedStatement ps=con.prepareStatement(“INSERT INTO MYTABLE(charCol, timestampCol) VALUES (?, ?)”);
ps.setString(1, “I am a String”);
java.util.Calendar gmtCalendar=new java.util.GregorianCalendar(“GMT”);
ps.setTimestamp(2, java.sql.Timestamp.valueOf(“2005-04-02 18:30:00”), gmtCalendar); ps.execute( );

In JDBC, the first argument in all java.sql.PreparedStatement.setXXX( ) methods is an int (i.e., integer), which always corresponds to the appropriate parameter marker (i.e., question mark) in the java.sql.XXX statement prepared by the connection. In the example usage scenario above, two values are being inserted, the first is a SQL CHAR value and the second is a SQL Timestamp value. To do this, setString (1, . . . ) and setTimestamp(2, . . . ) are called. The “1” corresponds to the first “?” in the java.sql.XXX statement prepared by the connection and the “2” corresponds to the second “?” in the java.sql.XXX statement prepared by the connection.

Calling java.util.Calendar gmtCalendar= . . . creates a java.util.Calendar object named “gmtCalendar” that is set to GMT. Calling java.sql.Timestamp.valueOf(“2005-04-02 18:30:00”) results in a new java.sql.Timestamp object that contains the epoch time corresponding to 18:30:00 PST on Apr. 2, 2005. The ps.setTimestamp(2, . . . ) statement then initiates the creation of an EnhancedTimestamp class 314 object based the “gmtCalendar” object and the newly created java.sql.Timestamp object.

The creation of the EnhancedTimestamp class 314 object is unknown to the user. As far as the user is concerned, only the java.sql.Timestamp class object is created. Using the “gmtCalendar” object, the local time of 2005-04-02 18:30:00 PST is converted to 2005-04-03 02:30:00 GMT and stored in the EnhancedTimestamp class 314 object.

In the example usage scenario, if 8 hours was simply added to the desired time, which is the difference between PST and GMT, then the time stored would be 2005-04-03 03:30:00 because 2005-04-03 02:30:00 does not exist in California due to the transition from Standard Time to Daylight Savings Time. Thus, the time stored would be incorrect.

In another example usage scenario, assume again that there is a database that is used by people all over the world and as a result, all time and date information is to be stored in GMT. Assume a second user located in California wishes to store the local time of “Saturday, Oct. 29, 2005 at 20:30:00” into the database. The user can create an object of the java.sql.Timestamp class to store the local time in GMT by calling:
java.sql.Connection con2; //assume this is a JDBC connection that is established java.sql.PreparedStatement ps2=con2.prepareStatement(“INSERT INTO MYTABLE(charCol, timestampCol) VALUES (?, ?)”);
ps2.setString(1, “This is a String”);
java.util.Calendar gmtCalendar2=new java.util.GregorianCalendar(“GMT”);
ps2.setTimestamp(2, java.sql.Timestamp.valueOf(“2005-10-29 20:30:00”), gmtCalendar2);
ps2.execute( );

Calling java.util.Calendar gmtCalendar2= . . . creates a java.util.Calendar object named “gmtCalendar2” that is set to GMT. Calling java.sql.Timestamp.valueOf(“2005-10-29 20:30:00”) results in a new java.sql.Timestamp object that contains the epoch time corresponding to 20:30:00 PDT on Oct. 29, 2005. The ps2.setTimestamp(2, . . . ) statement then initiates the creation of an EnhancedTimestamp class 314 object based the “gmtCalendar2” object and the newly created java.sql.Timestamp object.

As with the previous example, the creation of the Enhanced Timestamp class 314 object is unknown to the second user. The second user is only aware of the creation of a java.sql.Timestamp class object. Using the java.util.Calendar class object “gmtCalendar2”, the local time of 2005-10-29 20:30:00 PDT is converted to 2005-10-30 03:30:00 GMT and stored in the EnhancedTimestamp class 314 object.

In the example usage scenario, if 7 hours was simply added to the desired time, which is the difference between PDT and GMT, then the time stored would be 2005-10-30 02:30:00 because on Oct. 30, 2005, the clocks rolled back 1 hour in California due to the transition from Daylight Savings Time to Standard Time. Thus, the time stored would be incorrect.

By providing an enhanced class for each of the subclasses of the java.util.Date class, an object can be created to correctly store a specific instant in time in any time zone on any computer system. The object can then be passed to any application on any computer system to report a correct and consistent time value without any dependence on a computer system's local time zone. In addition, the creation of enhanced class objects is completely internal and invisible to users. As a result, users do not need to learn how to utilize the new classes.

The invention can take the form of an entirely hardware implementation, an entirely software implementation, or an implementation containing both hardware and software elements. In one aspect, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk read/write (CD-R/W).

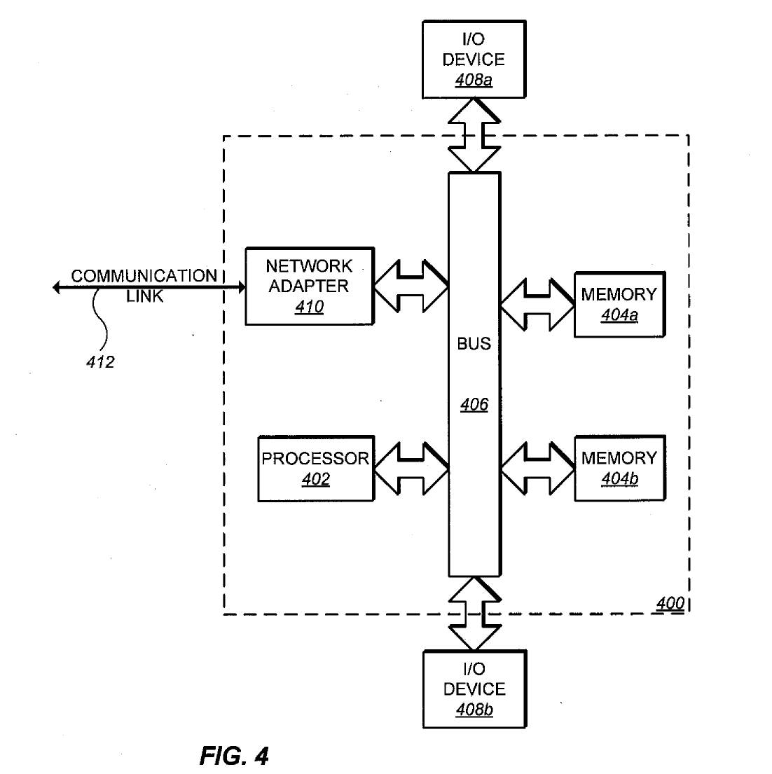

FIG. 4 depicts a data processing system 400 suitable for storing and/or executing program code. Data processing system 400 includes a processor 402 coupled to memory elements 404a-b through a system bus 406. In other implementations, data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to data processing system 400. I/O devices 408a-b may be coupled to data processing system 400 directly or indirectly through intervening I/O controllers (not shown).

In the implementation, a network adapter 410 is coupled to data processing system 400 to enable data processing system 400 to become coupled to other data processing systems or remote printers or storage devices through communication link 412. Communication link 412 can be a private or public network. Modems, cable modems, and Ethernet cards are just a few of the currently available types of network adapters.

While various implementations for storing specific instances in time as objects of the java.util.Date class have been described, the technical scope of the present invention is not limited thereto. Various modifications or improvements can be added to the above implementations and those modifications or improvements fall within the technical scope of the present invention.

What is claimed is:

1. A method for storing a specific instant in time as an object of the java.util.Date class, the method comprising:
defining a first enhanced class, the first enhanced class extending the java.sql.Date subclass of the java.util.Date class;
defining a second enhanced class, the second enhanced class extending the java.sql.Time subclass of the java.util.Date class;
defining a third enhanced class, the third enhanced class extending the java.sql.Timestamp subclass of the java.util.Date class;
creating a first object the first object being an object of the java.util.Calendar class;
creating a second object, the second object storing a specific instant in time in a first time zone and being an object of the java.sql.Date subclass, the java.sql.Time subclass, or the java.sql.Timestamp subclass; and
creating a third object based on the first object, the second object, and a provided value, the provided value corresponding to a second time zone,
the third object storing a particular instant in time in the second time zone corresponding to the specific instant in time in the first time zone, and
the third object being an object of the first enhanced class when the second object is an object of the java.sql.Date subclass, an object of the second enhanced class when the second object is an object of the java.sql.Time subclass, or an object of the third enhanced class when the second object is an object of the java.sql.Timestamp subclass.

2. The method of claim 1, further comprising:
defining a fourth enhanced class, the fourth enhanced class extending the java.util.Date class.

3. The method of claim 1, the first enhanced class comprises fields and methods corresponding to fields and methods of java.sql.Date, the second enhanced class comprises fields and methods corresponding to fields and methods of java.sql.Time, and the third enhanced class comprises fields and methods corresponding to fields and methods of java.sql.Timestamp.

4. The method of claim 1, wherein the provided value is an object of the java.util.TimeZone class.

5. The method of claim 1, wherein the particular instant in time in the second time zone corresponding to the specific instant in time in the first time zone is calculated using the first object.

6. A computer program product comprising a computer readable medium, the computer readable medium including a computer readable program for storing a specific instant in time as an object of the java.util.Date class, wherein the computer readable program when executed on a computer causes the computer to:
define a first enhanced class, the first enhanced class extending the java.sql.Date subclass of the java.util.Date class;
define a second enhanced class, the second enhanced class extending the java.sql.Time subclass of the java.util.Date class;
define a third enhanced class, the third enhanced class extending the java.sql.Timestamp subclass of the java.util.Date class;
create a first object, the first object being an object of the java.util.Calendar class;
create a second object, the second object storing a specific instant in time in a first time zone and being an object of the java.sql.Date subclass, the java.sql.Time subclass, or the java.sql.Timestamp subclass; and
create a third object based on the first object, the second object, and a provided value, the provided value corresponding to a second time zone,
the third object storing a particular instant in time in the second time zone corresponding to the specific instant in time in the first time zone, and
the third object being an object of the first enhanced class when the second object is an object of the java.sql.Date subclass, an object of the second enhanced class when the second object is an object of the java.sql.Time subclass, or an object of the third enhanced class when the second object is an object of the java.sql.Timestamp subclass.
